(19) United States
(12) Patent Application Publication
(10) Pub. No.: US 2026/0252958 A1
(43) Pub. Date: Aug. 27, 2026

(54) SYSTEM AND METHOD FOR DEVICE ATTRIBUTE IDENTIFICATION BASED ON HOST CONFIGURATION PROTOCOLS

(71) Applicant: Armis Security Ltd., Tel Aviv-Yafo (IL)

(72) Inventors: Yuval Friedlander, Petah Tiqwa (IL); Gil Ben Zvi, Hod Hasharon (IL); Tom Hanetz, Tel Aviv (IL); Ron Shoham, Tel Aviv (IL)

(73) Assignee: Armis Security Ltd., Tel Aviv-Yafo (IL)

(21) Appl. No.: 19/530,243

(22) Filed: Feb. 4, 2026

Related U.S. Application Data
(63) Continuation of application No. 17/655,845, filed on Mar. 22, 2022, now Pat. No. 12,572,846.

(51) Int. Cl. G06N 20/00

(52) U.S. Cl. CPC G06N 20/00

(57) ABSTRACT

The invention provides a security system and method for use in a communications network, said network comprising means to allow a plurality of devices to communicate over the network wherein at least one device is a machine to machine (M2M) operated device and at least one other device is a human operated device, said security system comprising: means to capture data traffic originating from the plurality of devices on the network; means for analysing the data traffic; and means for identifying at least one of the M2M operated devices on the network wherein the system is configured to dynamically adapt to different data traffic patterns on the network.

### TECHNICAL FIELD

The present disclosure relates generally to identifying device attributes such as operating system for use in cybersecurity for network environments, and more specifically to identifying device attributes using host configuration protocols.

### BACKGROUND

Cybersecurity is the protection of information systems from theft or damage to the hardware, to the software, and to the information stored in them, as well as from disruption or misdirection of the services such systems provide. Cybersecurity is now a major concern for virtually any organization, from business enterprises to government institutions. Hackers and other attackers attempt to exploit any vulnerability in the infrastructure, hardware, or software of the organization to execute a cyber-attack. There are additional cybersecurity challenges due to high demand for employees or other users of network systems to bring their own devices, the dangers of which may not be easily recognizable.

To protect networked systems against malicious entities accessing the network, some existing solutions attempt to profile devices accessing the network. Such profiling may be helpful for detecting anomalous activity and for determining which cybersecurity mitigation actions are needed for activity of a given device. Providing accurate profiling is a critical challenge to ensuring that appropriate mitigation actions are taken.

The challenge involved with profiling a user device is magnified by the fact there is no industry standard for querying or obtaining information from user devices. This challenge is particularly relevant when attempting to determine device attributes. As new types of devices come out frequently and there is not a single uniform standard for determining device attributes in data sent from these devices, identifying the attributes of devices accessing a network environment is virtually impossible.

More specifically, as device data is obtained from various sources, device attributes such as operating system may be absent or conflicting in data from the various sources. For example, this may be caused by partial visibility over network traffic data due to deployment considerations, partial coverage due to sampled traffic data as opposed to continuously collected traffic data, continuous and incremental collection of device data over time, and conflicting data coming from different sources.

The traffic data available between clients and servers may contain host configuration protocol data in the form of packets. An example of such a host configuration protocol is Dynamic Host Configuration Protocol (DHCP), which allows a server to dynamically distribute Internet Protocol (IP) address and configuration data to clients. When a client becomes configured to begin communicating subject to DHCP, the client sends a DHCP discovery packet identifying itself. The server returns a DHCP offer packet to the client. The client, in turn, responds to the DHCP offer packet with a DHCP request packet to verify the offered address. The server sends a pack packet, thereby completing the initialization sequence. When the client sends a discover or request packet, the packet typically includes a list of one or more DHCP options.

Solutions for ensuring complete and accurate device attribute data are therefore highly desirable.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for determining device attributes based on host configuration protocols. The method comprises: applying at least one machine learning model to a test data set extracted from host configuration protocol data including at least one test options sequence, wherein each test options sequence is an ordered series of options requested by a first device, wherein each of the at least one machine learning model is trained based on a train data set including a plurality of training options sequences and a plurality of device attributes, wherein each training options sequence and each device attribute of the train data set corresponds to a respective second device; and determining, based on the output of the at least one machine learning model, at least one device attribute for the first device.

Certain embodiments disclosed herein also include a non-transitory computer readable medium having stored thereon causing a processing circuitry to execute a process, the process comprising: applying at least one machine learning model to a test data set extracted from host configuration protocol data including at least one test options sequence, wherein each test options sequence is an ordered series of options requested by a first device, wherein each of the at least one machine learning model is trained based on a train data set including a plurality of training options sequences and a plurality of device attributes, wherein each training options sequence and each device attribute of the train data set corresponds to a respective second device; and determining, based on the output of the at least one machine learning model, at least one device attribute for the first device.

Certain embodiments disclosed herein also include a system for determining device attributes based on host configuration protocols. The system comprises: a processing circuitry; and a memory, the memory containing instructions that, when executed by the processing circuitry, configure the system to: apply at least one machine learning model to a test data set extracted from host configuration protocol data including at least one test options sequence, wherein each test options sequence is an ordered series of options requested by a first device, wherein each of the at least one machine learning model is trained based on a train data set including a plurality of training options sequences and a plurality of device attributes, wherein each training options sequence and each device attribute of the train data set corresponds to a respective second device; and determine, based on the output of the at least one machine learning model, at least one device attribute for the first device.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for securing a network environment by identifying device attributes based on host configuration protocol data according to an embodiment.

FIG. 3 is a flowchart illustrating a method for training machine learning models to determine device attributes based on host configuration protocol data according to an embodiment.

FIG. 4 is a schematic diagram of a device attribute identifier according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

It has been identified that device attributes, particularly operating system used by the device, can be identified with a high degree of accuracy using data related to host configuration protocols (e.g., the Dynamic Host Configuration Protocol standard defined by RFC 1541). More specifically, it has been identified that the fields used for requesting parameters in certain host configuration protocol packets (such as DHCP Parameter Request List option 55) demonstrate patterns which can be leveraged in order to identify a device's operating system.

These patterns appear at least in the order by which the client requests options via the Parameter Request List field in the DHCP option 55 packet. To this end, it is noted that, when a device sends a discover or request packet for certain types of host configuration protocols such as DHCP, the device includes a list of options (e.g., DHCP options) which the device intends to receive from the server to which the packet is sent. The order by which the client requests these options from the server is unique and can be used to fingerprint a particular operating system.

It has further been identified that, although a rules-based mechanism defining certain predetermined patterns to look for when analyzing traffic could be used, such a rules-based mechanism would not provide suitable reliability due to variations in patterns that may occur. Specifically, relying on a rules-based mechanism would yield unreliable predictions with low coverage rates. Further, such a rules-based mechanism would require manual definitions, tuning, and maintenance, which would hinder procedural scalability.

Accordingly, the disclosed embodiments provide techniques for identifying device attributes such as operating system using host configuration protocol data such as data in the Parameter Request List field in DHCP option 55 packets. The disclosed embodiments further provide techniques to improve device attribute identification using machine learning. The disclosed embodiments therefore provide techniques for identifying device attributes using machine learning that demonstrate higher reliability and scalability than manual techniques. Also, various disclosed embodiments provide specific techniques for improving the accuracy of the machine learning process in the context of device attribute identification using host configuration protocol data. Such techniques include techniques for normalizing, filtering, and grouping the data that yield better tuned machine learning models when used for training, which in turn improves the accuracy of device attributes determined using outputs of the machine learning models.

In various disclosed embodiments, predictions of device attributes using the trained machine learning model are used to monitor device activity in order to detect abnormal behavior which may be indicative of cybersecurity threats. To this end, the determined device attributes may be added to device profiles for devices and used in accordance with device normal behaviors of devices having certain combinations of device attributes in order to identify potentially abnormal behavior. When abnormal behavior is detected, mitigation actions may be performed in order to mitigate potential cybersecurity threats. Due to the improved machine learning noted above, using device attributes determined as described herein further allows for more accurately identifying and mitigating potential cybersecurity threats, thereby improving cybersecurity for networks in which such devices operate.

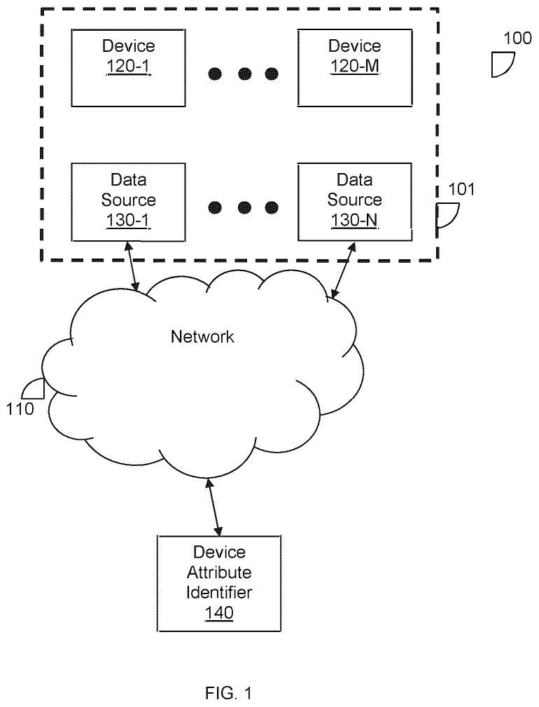

FIG. 1 shows an example network diagram 100 utilized to describe the various disclosed embodiments. In the example network diagram 100, data sources 130-1 through 130-N (hereinafter referred to as a data source 130 or as data sources 130) communicate with a device attribute identifier 140 via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The data sources 130 are deployed such that they can receive data from systems deployed in a network environment 101 in which devices 120-1 through 120-M (referred to as a device 120 or as devices 120) are deployed and communicate with each other, the data sources 130, other systems (not shown), combinations thereof, and the like. The data sources 130 may be, but are not limited to, databases, network scanners, both, and the like. Data collected by or in the data sources 130 may be transmitted to the device attribute identifier 140 for use in determining device attributes as described herein. To this end, such data includes protocol strings indicating at least protocols used to send the strings and keys for encrypting data pursuant to an IP session in which the strings are sent.

Each of the devices 120 may be, but is not limited to, a personal computer, a laptop, a tablet computer, a smartphone, a wearable computing device, or any other device capable of receiving and displaying notifications. Each device 120 may utilize a communications protocol which may be indicated in data transmitted by the device 120 such that communications by the device 120 are formatted in accordance with string conventions defined by that protocol. As discussed herein, such protocols define requirements for inclusion of protocol and key data which may be utilized to determine device attributes for each of the devices 120.

The device attribute identifier 140 is configured to determine device attributes of the devices 120 based on host configuration protocol data obtained from the data sources 130. More specifically, the device attribute identifier 140 is configured to apply one or more machine learning models trained to predict device attributes such as operating systems as described herein.

During a training phase, the machine learning models are trained using training data obtained by reading device and host configuration data files. In particular, the data obtained by reading device and host configuration data files includes at least options data sent in packets by the device during initialization of a host configuration protocol such as DHCP. As noted above, it has been identified that the order in which options are sent (e.g., an order of an options list) strongly correlates to devices of certain types and, in particular, devices using certain operating systems for communications with a server. In a further embodiment, the options data includes DHCP option 55 data.

Data to be used for training and applying the machine learning models is obtained and processed. The processing may include, but is not limited to, normalizing device attributes indicated therein, grouping such device attributes, filtering device, extracting features (e.g., request parameter frequencies), normalizing such features, combinations thereof, and the like. The processing may further include splitting the data into disjoint train and test data sets, where the train data set is used to train the machine learning models and the trained models are applied to the test data set.

It should be noted that the device attribute identifier 140 is depicted as being deployed outside of the network environment 101 and the data sources 130 are depicted as being deployed in the network environment 101, but that these depictions do not necessarily limit any particular embodiments disclosed herein. For example, the device attribute identifier 140 may be deployed in the network environment 101, the data sources 130 may be deployed outside of the network environment 101, or both.

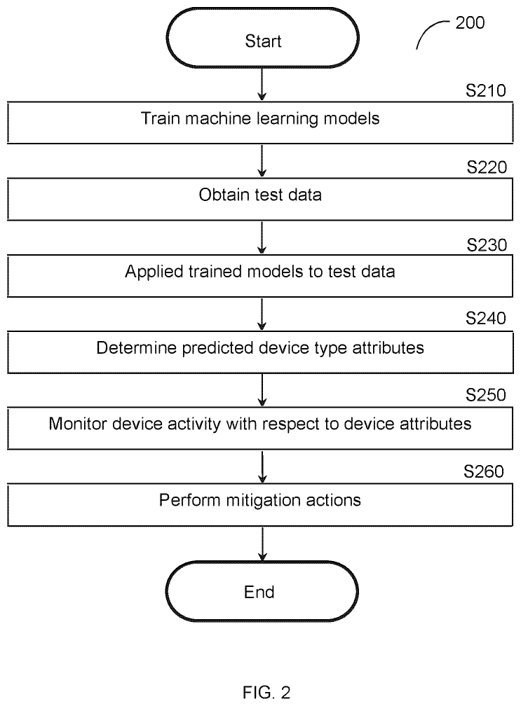

FIG. 2 is an example flowchart 200 illustrating a method for securing a network environment by identifying device attributes based on host configuration protocols according to an embodiment. In an embodiment, the method is performed by the device attribute identifier 140, FIG. 1.

At S210, one or more machine learning models are trained to yield predictions of device attributes based on host configuration protocol data. In an embodiment, each machine learning model is a classifier trained to output, for each sequence of options sent by a device, probabilities for respective classes. Each class, in turn, may correspond to a label representing a device attribute (e.g., a particular operating system).

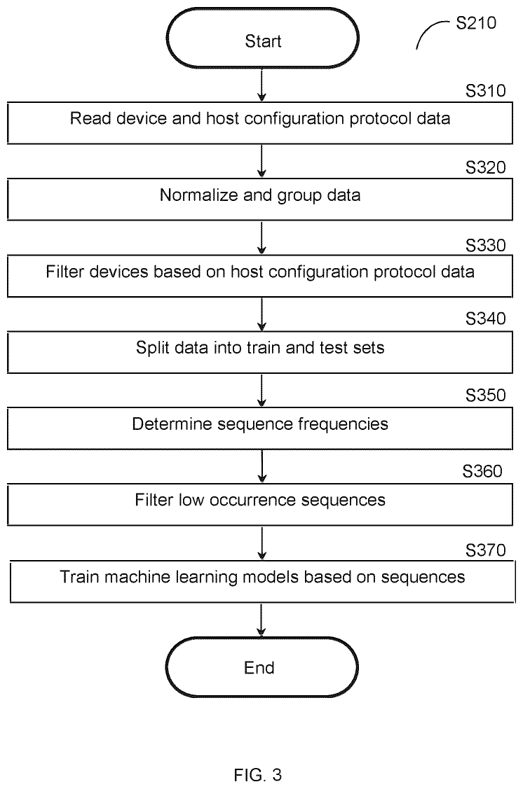

In an embodiment, the machine learning models are trained using a process as depicted with respect to FIG. 3. FIG. 3 is a flowchart S210. illustrating a method for training machine learning models to determine device attributes based on host configuration protocol data according to an embodiment.

At S310, device and host configuration protocol data are read. The data may be read from packets sent, for example, during an initiation sequence (e.g., the initiation sequence for DHCP communications). In accordance with various disclosed embodiments, the data that is read includes packets or portions of packets (e.g., the Parameter Request List field in a DHCP packet) including an ordered sequence of options. As noted above, specific orders of options tend to correspond to particular operating systems such that they can be leveraged to predict operating systems or other device attributes.

At S320, the data read at S310 is normalized and grouped. The normalization may include, but is not limited to, cleaning data, data type normalization, formatting normalization, combinations thereof, and the like. In an embodiment, device attribute values indicated in the data may be normalized.

In an embodiment, at least a portion of the data may be grouped. More specifically, during a training phase, data may be grouped with respect to device attributes such that data including device attribute values may be grouped into groups of device data indicating the same device attributes. For example, device data may be grouped with respect to operating systems. In some embodiments, data may be grouped into an “OTHER” group. For example, the “OTHER” group may include data having device attributes that are absent from a whitelist of device attributes. During a prediction phase, predictions may be yielded for each device individually.

At S330, devices represented in the data are filtered based on host configuration protocol data. The filtering may be performed to remove or otherwise regroup data to be used for training learning models to be used for determining predicted device attributes, thereby further improving the accuracy of device attribute inferences made using those models. In an embodiment, devices for which there is host configuration protocol data is missing may be filtered out. As a non-limiting example, devices for which DHCP request parameters data is absent in the host configuration protocol data are filtered out.

At S340, the data is split into train and test sets. In an embodiment, S340 may include sampling the data. As a non-limiting example, stratified sampling may be applied such that each class (e.g., each device attribute) is represented in both the train and test sets in accordance with its overall frequency within the population.

At S350, a frequency is determined for each options sequence with respect to each device attribute. In an embodiment, each determined frequency is a ratio in which each sequence was observed for each device attribute as compared to the total number of instances of the sequence over different possible device attributes (e.g., over all operating systems).

As a non-limiting example, the device attributes include a first operating system “opSys-A” and a second operating system “opSys-B”, and options sequences included in data for devices include the following:
Sequence 1: optA, optB, optC
Sequence 2: optX, optY, optZ

In this example, optA, optB, optC, optX, optY, and optZ are different options sent in sequential order. When sequences for device data for sequence 1 include 80 instances over “opSys-A” and 20 instances over “opSys-B,” the frequencies for sequence 1 with respect to operating system “opSys-A” and “opSys-B” are 0.8 and 0.2, respectively.

At S360, low occurrence sequences are filtered out from the train data set in order to create a filtered train data set. The low occurrence sequences may include, but are not limited to, sequences that were observed (i.e., included in the data) less than a threshold number of times, sequences that were observed below a threshold proportion of total sequences for a given device attribute, or both. The threshold proportion of total sequences applied to each sequence may be defined with respect to a device attribute (e.g., a particular operating system) for which the sequence had the highest determined frequency. This filtering ensures significance of the data used for training the models and minimizes false positives.

In this regard, it is noted that a given options sequence may correspond to more than one device attribute (e.g., more than one operating system). By determining a proportion of a given sequence for the device attribute having the highest frequency for the sequence and filtering based on this determined proportion, only the most uniquely identifying sequence-attribute correlations are used to train the models, thereby improving the models and, consequently, improving device attribute predictions made using model outputs.

At S370, one or more machine learning models are trained based at least on the options sequences and device attribute values included in the train set. Each model is configured to output one or more probabilities, with each probability corresponding to a respective class representing a device attribute. Since the models are trained using options sequences and device attribute values, the models allow for learning correlations between option sequences and particular device attributes.

Returning to FIG. 2, at S220, test data is obtained. In an embodiment, the test data may be included in traffic data and split from training data as described above with respect to S340. Alternatively or collectively, the test data may be new data obtained by observing packets sent by devices in a network environment.

In an embodiment, the test data may be preprocessed before applying the machine learning models to the test data. Such preprocessing may include, but is not limited to, extracting features to which the machine learning models will be applied. The extracted features may include, but are not limited to, data extracted from certain fields in packets (for example, the Parameter Request List field in a DHCP option 55 packet).

At S230, the trained machine learning models are applied to the test data in order to yield predictions of device attributes. In an embodiment, the machine learning models are each trained to output scores corresponding to different potential device attributes. In a further embodiment, each model may output multiple scores (i.e., scores for different potential device attributes) for each sequence of options sent by each device.

At S240, based on the output of the machine learning models, one or more predicted device attributes are determined (i.e., for one or more respective devices whose data is included in the test data).

In an embodiment, the machine learning models output a probability for each class among multiple potential classes, where each class represents a potential device attribute. For example, a machine learning model may be trained to output respective probabilities for various operating systems. In a further embodiment, the machine learning models may output multiple probabilities for a given device, for example, a probability for each sequence of options included in packets sent by to the device (e.g., an order of options sent in packets by the device during an initiation sequence).

In yet a further embodiment, the predicted device attribute is a device attribute corresponding to a class having the highest probability after averaging probabilities over multiple device sequences for the device. Moreover, in some embodiments, only classes having respective probabilities above a threshold are used to determine predicted device attributes. Different thresholds may be set for different classes (e.g., for different operating systems).

At S250, device activity of one or more devices is monitored for abnormal behavior based on the determined device attributes.

In an embodiment, S250 includes adding the device attributes to respective profiles of devices for which the device attributes were determined and monitoring the activity of those devices based on their respective profiles. In such an embodiment, one or more policies define allowable behavior for devices having different device attributes such that, when a device having a certain device attribute or combination of device attributes deviates from the behavior indicated in the policy for that device attribute, the device's current behavior can be detected as abnormal and potentially requiring mitigation. The policy may be defined based on previously determined profiles including known device behavior baselines for respective devices. In a further embodiment, normal behavior patterns with respect to certain combinations of device attributes may be defined manually or learned using machine learning, and S250 may include monitoring for deviations from these normal behavior patterns.

At S260, one or more mitigation actions are performed in order to mitigate potential cyberthreats detected as abnormal behavior at S250. The mitigation actions may include, but are not limited to, severing communications between a device and one or more other devices or networks, generating an alert, sending a notification (e.g., to an administrator of a network environment), restricting access by the device, blocking devices (e.g., by adding such devices to a blacklist), combinations thereof, and the like. In some embodiments, devices having certain device attributes may be blacklisted such that devices having those device attributes are disallowed, and the mitigation actions may include blocking or severing communications with devices having the blacklisted device attributes.

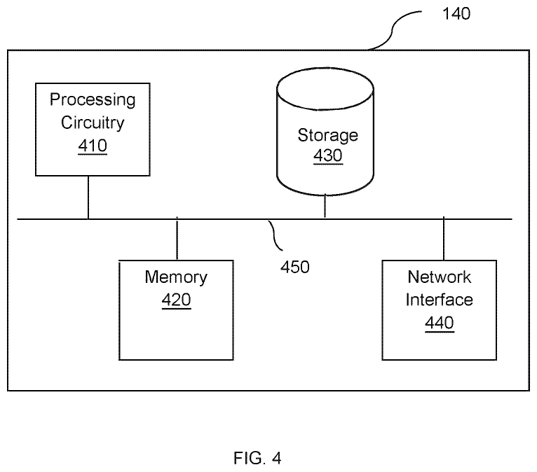

FIG. 4 is an example schematic diagram of a device attribute identifier 140 according to an embodiment. The device attribute identifier 140 includes a processing circuitry 410 coupled to a memory 420, a storage 430, and a network interface 440. In an embodiment, the components of the device attribute identifier 140 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., random access memory, etc.), non-volatile (e.g., read only memory, flash memory, etc.), or a combination thereof.

In one configuration, software for implementing one or more embodiments disclosed herein may be stored in the storage 430. In another configuration, the memory 420 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 440 allows the device attribute identifier 140 to communicate with, for example, the data sources 130, FIG. 1.

It should be understood that the embodiments described herein are not limited to the specific architecture illustrated in FIG. 4, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. (canceled)

2. A computer-implemented method comprising:
obtaining data associated with a device;
determining a particular device attribute associated with the device by processing the data via a trained machine learning model;
monitoring the device, based on the particular device attribute, to determine a behavior of the device;
detecting a cyberthreat associated with the behavior of the device by comparing the behavior of the device against one or more predefined allowable behaviors; and
performing at least one mitigation action to address the cyberthreat.

3. The computer-implemented method of claim 2, wherein the trained machine learning model processing the data includes the trained machine learning model:
generating, based on the data, a plurality of probability values respectively associated with a plurality of attributes associated with the device; and
selecting the particular device attribute from among the plurality of attributes.

4. The computer-implemented method of claim 3, wherein selecting the particular device attribute includes determining that a respectively probability value associated with the particular device attribute is a highest among the plurality of probability values.

5. The computer-implemented method of claim 3, wherein each of the plurality of probability values indicates a probability of a respective sequence of options included in packets from the device.

6. The computer-implemented method of claim 2, wherein the data includes a series of packets, and wherein determining the particular device attribute includes extracting one or more features from the series of packets.

7. The computer-implemented method of claim 6, wherein extracting the one or more features includes extracting one or more configuration parameters.

8. The computer-implemented method of claim 6, wherein the series of packets includes a host configuration protocol packet.

9. The computer-implemented method of claim 6, wherein extracting the one or more features includes extracting a plurality of ordered sequences of options.

10. The computer-implemented method of claim 6, wherein the series of packets is received from the device as part of an initiation sequence of the device.

11. The computer-implemented method of claim 2, wherein the particular device attribute corresponds to an operating system running on the device.

12. The computer-implemented method of claim 2, wherein detecting the cyberthreat includes detecting a deviation between the behavior of the device and the one or more predefined allowable behaviors.

13. The computer-implemented method of claim 2, wherein the at least one mitigation action includes severing communications between the device and other devices or networks, generating an alert, or sending a notification.

14. The computer-implemented method of claim 2, wherein the at least one mitigation action includes restricting access of the device by blacklisting the device.

15. The computer-implemented method of claim 2, further comprising generating the trained machine learning model by:
extracting a plurality of ordered sequences of options;
filtering a subset of the plurality of ordered sequences to generate filtered training data; and
training a machine learning model using the filtered training data.

16. The computer-implemented method of claim 15, wherein each ordered sequence of options is obtained from a parameter request list field of a host configuration protocol packet.

17. The computer-implemented method of claim 15, wherein the filtering is based on ordered sequences that occur:
less than a threshold number of times; and/or
below a threshold proportion of a total number of the plurality of ordered sequences.

18. A system comprising:
one or more processors; and
one or more memories configured to store instructions that, when executed by the one or more processors, perform operations comprising:
obtaining data associated with a device;
determining a particular device attribute associated with the device by processing the data via a trained machine learning model;
monitoring the device, based on the particular device attribute, to determine a behavior of the device;
detecting a cyberthreat associated with the behavior of the device by comparing the behavior of the device against one or more predefined allowable behaviors; and
performing at least one mitigation action to address the cyberthreat.

19. The system of claim 18, wherein the data includes a series of packets, and wherein determining the particular device attribute includes extracting one or more features from the series of packets.

20. The system of claim 19, wherein the series of packets is received from the device as part of an initiation sequence of the device.

21. One or more non-transitory, computer-readable media storing instructions that, when executed by one or more processors, cause the one or more processors to perform operations comprising:
obtaining data associated with a device;
determining a particular device attribute associated with the device by processing the data via a trained machine learning model;
monitoring the device, based on the particular device attribute, to determine a behavior of the device;
detecting a cyberthreat associated with the behavior of the device by comparing the behavior of the device against one or more predefined allowable behaviors; and
performing at least one mitigation action to address the cyberthreat.
